(19) United States
(12) Patent Application Publication
(10) Pub. No.: US 2010/0161436 A1
(43) Pub. Date: Jun. 24, 2010

(54) Digital media review and play system

(75) Inventors: Boris Itskov, Thornhill (CA); Peter A. Guterres, Toronto (CA); Valery Levitan, Toronto (CA)

Correspondence Address: DENNISON ASSOCIATES, 133 RICHMOND STREET WEST, SUITE 301, TORONTO, ON, M5H 2L7, CA

(73) Assignee: JVL Corporation, Concord, ON (CA)

(21) Appl. No.: 12/308,344

(22) PCT Filed: Jun. 8, 2007
(86) PCT No.: PCT/CA2007/001021

§ 371 Date: Feb. 2, 2010

(30) Foreign Application Priority Data
Jun. 8, 2006 (CA) 2,549,816

(51) Int. Cl. G06Q 50/00; G06F 21/24; G06Q 30/00; G06Q 40/00

(52) U.S. Cl. 705/26; 726/30; 705/30; 700/94

(57) ABSTRACT

A media control system allows the play of media files from customers or users in a public establishment. A digital content review arrangement communicates with a control gate that forwards to the digital content review arrangement requested media files or summary information of the media files sufficient to identify the requested media files with known media files contained in a database of the digital content review arrangement or available thereto. The control gate includes an input for communicating with personal portable digital content devices of customer and/or users and receives therefrom requested media files to be played on a media play system of said public establishment. The control gate forwards the requested media files received from said personal portable digital content devices to said digital content review arrangement for identification. The control gate also provides to the media play system any of the requested media files that have been identified by said digital content review arrangement. The digital content review arrangement preferably tracks the play of identified media files on the media play system. This control system is appropriate for various media files including audit files, video files and game files.

### FIELD OF THE INVENTION

The present invention relates to a method and system for play authorized of multimedia content in a public establishment.

### BACKGROUND OF THE INVENTION

It is common in public establishments to have an in-house audio/video system play music and/or video recordings in accordance with the particular decisions of the owner or on a client selected basis such as would be common with jukeboxes. It is also known to have game terminals suitable for more selected viewing of video content and/or the playing of video games. Various arrangements for the appropriate payment of copyright or performance fees are prearranged by the owner based on contents of the database. Typically, the database is onsite.

The ability to store a host of audio or video files on personal portable devices has allowed users to easily transport their music or video files for selective personal play at diverse locations or activities. Due to the low cost capability to store digital content, the selected music and/or video may vary widely. It is also now quite cost effective to store a large number of video or audio files suitable for play on a public system.

These personal and commercial systems may also provide summary information, ID tags, allowing music and/or videos to be easily identified, categorized and sorted.

For certain applications, it would be desirable as a customer or user, to have certain personal audio and/or video files available for play in a public establishment. For example, if a large group is meeting at a particular restaurant or establishment, it would be desirable to schedule both the audio and video content that will be played at that point in time using the in-house system and/or selected devices within the public establishment. Furthermore, it would be desirable from the establishment's point of view that this function be carried out in an automated or semi-automated manner as determined by the owner. In such an automated system it would be desirable to include the ability to pay for the playing of particular audio and video content including any licensing or performance fees as may be legally required. It would also be desirable to specify particular devices within the establishment for selective play of the audio and video content.

Various arrangements are disclosed in the present application for carrying out these functions and variations thereof.

### SUMMARY OF THE INVENTION

A media control system for the play of media files in a public establishment according to the present invention comprises a digital content review arrangement in communication with a control gate that forwards to the digital content review arrangement, media files or summary information of the media files sufficient to identify, if possible, the media files with known media files or summary information contained in a database of the digital content review arrangement or available to the public establishment. The control gate includes an input for communicating with personal portable digital content devices and receives therefrom media files or identification information of files requested to be played on a media play system of the public establishment. The control gate forwards the requested media files or identification information received from the personal portable digital content devices to the digital content review arrangement for identification. The control gate provides to the media play system any of the media files or identification information that has been identified by the digital content review arrangement. The digital content review arrangement preferably also tracks the play of identified media files on the media play system.

The control gate preferably acts as an intermediary between the electronic devices of the customers and the audio/video system of the public establishment. The control gate receives identification information of the digital content from the electronic devices, and once identified in the database of the digital content review system, the digital content may be played by the system. The digital content review system preferably has a prearranged license or arrangement in respect of the copyright or performance fees. With this arrangement, only the identification information needs to be transferred.

In a preferred aspect of the invention, the control gate includes a touch screen for user input and software providing input screens to allow the connection of a personal portable digital content device and the transfer or streaming of media files or identification information (to allow access to the content) for possible play on the media play system.

In a further aspect of the invention, the control gate includes a payment arrangement allowing the user to pay the particular fee for playing of identified media files on the media play system.

In a different aspect of the invention, the digital content review arrangement includes an accounting function and the database of media files includes royalty payment information. The accounting function tracks media file play information and royalty information to allow payments and reports to a licensing group or groups.

In a further aspect of the invention, the control gate is part of a video game terminal including a payment receiving capability.

In a different aspect of the invention, the personal portable digital content device includes hand held game consoles and the media files are game files.

In a preferred aspect of the invention, the personal portable digital content devices include cell phones, iPod type devices, MP3 players and memory devices.

In an aspect of the invention, the digital content review arrangement includes a communication server and a data processing server.

In a preferred arrangement of the invention, a series of control gates are provided with each control gate in communication with the digital content review arrangement. A series of media play systems are also provided and controlled by said control gates for playing of requested media files.

In a different arrangement of the invention, the control gates are part of a separate media play system that plays predetermined media files not provided by a user.

In a further aspect of the invention, the audio and/or video content is provided from a remote database source, preferably as streaming multimedia content, video and/or audio content that is played by the system at the time of receipt. This arrangement may simplify the licensing of the content being played as it is not stored for subsequent repeated play.

### BRIEF DESCRIPTION OF THE DRAWINGS

Preferred embodiments of the invention are shown in the drawings, wherein:

FIG. 1 is a schematic overview of the system;

FIG. 2 is a schematic of an alternate system;

FIG. 3 is a schematic of the equipment in the commercial establishment of the alternate system;

FIG. 4 is a schematic of the Digital Content Management System and Licensing Authorities of the alternate system;

FIG. 5 is a schematic showing further details of the Music on Demand Provider and the Content Provider illustrated in the alternate system of FIG. 2;

FIG. 6 is a schematic showing details of the media center used to act as a control arrangement;

FIGS. 7 and 8 are schematics of alternate arrangements;

FIGS. 9 through 14 show a series of user access menus for inputting instructions to the system; and

FIGS. 15 and 16 show variations of the systems.

### DETAILED DESCRIPTION OF THE PREFERRED EMBODIMENTS

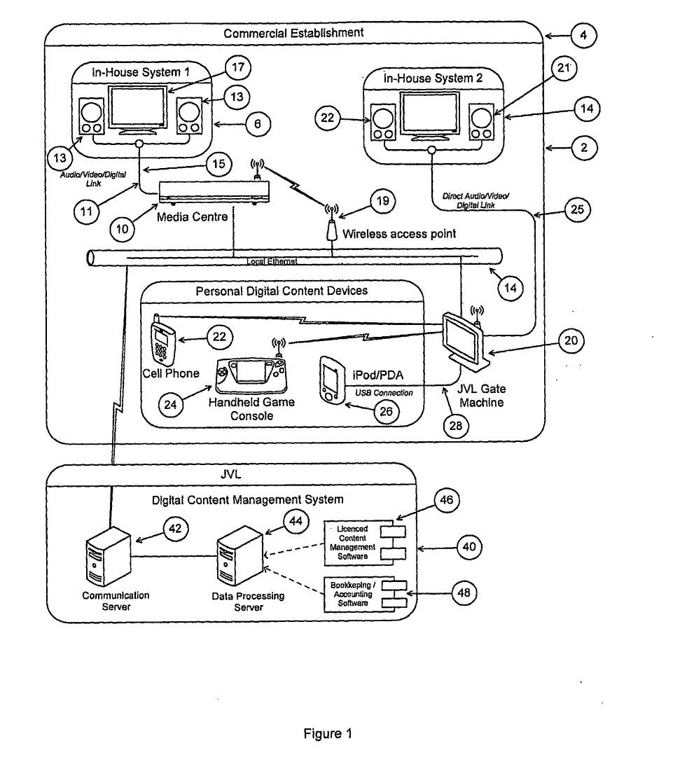

The media play system 2 shown in FIG. 1 is for use in a commercial or public establishment generally indicated as 4. Such commercial establishments include restaurants, night clubs and other public entertainment facilities or businesses. The performance or play of digital content, subject to copyright protection, (audio video, game contents, etc.) in public establishments requires appropriate authorization.

Shown within the commercial establishment is a first in-house system 6 and a second in-house system 8. The in-house systems 6 and 8, each typically include an amplifier 9 for receiving a signal from one or more source devices such as a CD player, hard drive, receiver etc. The signal is appropriately processed and provided to the speakers 13. This type of device can also control the video source signal. The media center 10 provides a communication and control switch function for integrating control gate 20 into existing systems.

Preferably, the various sources of multi-media content are connected to the media center 10 and the media center 10 provides the appropriate signal to one or more of the in-house systems 6 and 8. The control gate 20 can interrupt signals from other sources to the amplifier and essentially override other sources as may be required. In this way, the control gate and media center provide a switch function for controlling the content on the in-house systems.

Advantageously, the control gate and media center 10 cooperate with existing audio/video systems.

The first in-house system 6 includes an audio link 11 connecting a pair of speakers 13 to the media center 10. A video link 15 connects the media center 10 to a display screen 17. The media center 10 includes a connection 12 to the local Ethernet network 14 and is typically in communication with the digital management system 40 over the INTERNET. The digital management system can store and provide audio and video content to the in-house system 6 in a somewhat conventional manner as the content and licensing provisions have been established, allowing the digital management system to provide or authorize the specific use of the digital content. Preferably, the digital management system is remotely located but this system could be located on site. The local Ethernet network can include a wireless transmission and receive capability 19 for communication with other related components, including an INTERNET connection with the remotely located server 42 of the digital management system.

The second in-house system 8 includes a pair of speakers 21, a display screen 23 and signal processing arrangement, and a direct digital link 25 connecting these components to the control gate 20. This embodiment also includes the control of signals to the in-house system 8. This arrangement may be appropriate for less sophisticated applications or systems as a separate media center 10 is not used.

The control gate 20 allows effective communication with any of a series of personal digital content devices such as the cell phone 22, the handheld game console 24, and/or the iPod/PDA 26. These personal digital content devices are owned by a customer and are capable of communicating in a wireless communication with the control gate 20. In addition, there can be a hard wire connection such as a USB connection 28 connecting a video player and/or iPod/PDA 26 with the control gate 20. Any of the personal digital content devices can include a suitable arrangement for effective communication with the control gate 20 including (as examples) a digital connection such as WiFi, infrared, GPRS, 3G, Bluetooth, HDMI and Optical Link, or by an analog link. These personal digital content devices are controlled by the user and digital files contained therein or identification information of the particular files can be effectively communicated to the control gate 20 for eventual play on the in-house system 8. The actual digital content can be provided from different sources in communication with the control gate.

The control gate 20 provides a coordinating function used to identify the content about to be played on the in-house system 8. This content or summary identification information can be communicated to the communication server 42 over the local Ethernet network 14 and reviewed by the digital processing server 44. In this way, the content about to be played on the in-house system 8 can be audited to provide the appropriate tracking of digital media content played in the commercial establishment. For example, if the audio content includes a series of songs, these songs can be identified and appropriately authorized for play on the in-house system 8. This authorization can also be used with respect to video content. The actual files or media content played may be provided by a local or remote database.

In some cases, the material being forwarded by one of the personal digital content devices will not be subject to copyright provisions, as the owner is unknown, or perhaps the user is already the owner. Therefore there may be some material that can be used with the in-house system 8 without authorization from the digital content Management System. For example, a certain office group may plan a marketing or sales meeting and wish to display this audio/video content for review in a more informal session. As the copyright owner is effectively the owner of the personal digital content, no further compensation would be required.

In contrast, particularly for audio content, the material may be music and this music or summary identification information may be reviewed to determine whether authorization is required. As technology advances, the music content can be analyzed to compare it to a host of known digital content for appropriate identification and any required authorization.

The control gate 20 includes the direct audio/video/digital link 25 to the in-house system 8. With this system, the customer who owns one of the personal digital content devices 22, 24, and 26, for example, has loaded these devices with music, video games, digital pictures, multimedia files, etc. that they wish to play on the in-house system 8. A suitable connection is made with the control gate 20 that typically includes a touch screen and software for effective communication with these devices. The information is then provided to the in-house system 8.

The digital management system 40 reviews digital content or ID information communicated thereto by the control gate and the data processing server 44 reviews and tracks the digital content for reporting to the appropriate Content Providers.

With this system, users of portable devices can have the content stored internally or can have access to an external source, for example, a satellite radio receiver or a source of streaming audio and/or video content. The important aspect is that the customer is in control of identifying the digital content. The control gate 20 is connected to the in-house multimedia system at the commercial establishment and transmits the user's selection to the system. The control gate 20 is connected to a digital control management system that verifies the content and tracks copyright payment information. This digital control management system process is typically carried out remotely of the commercial establishment. The control gate allows play of the selection through the above mentioned audio or video connection. The control gate 20 is preferably part of other systems that include a payment facility such as a video game terminal and/or a digital jukebox. As can be appreciated, this particular ability to allow the user to provide or identify the audio or video content, can advantageously supplement existing digital or video systems.

The control gate 20 provides the ability to select audio/video files to be played and/or the personal digital content device allows the user to select the files. The system is capable functioning in both of these manners. As the capability of personal digital content devices continues to expand, their use as an input device to select files will also expand.

With this arrangement, the control gate 20 coordinates examination of the content to be played by the customer and appropriately classifies this information in combination with the digital content management system 40. The digital content management system 40 provides the results of the review of the content to the control gate and the appropriate authorization for this play of the selected digital content. This content can also include real time streaming of audio and/or video content to the control gate.

The digital content management system 40 includes a bookkeeping function to record and process all the payment information and content identifying information including the digital content title (ID), number of times played, and/or the duration of each, and the total play time, depending on the content. This also provides copyright control and monitoring. For example, the control gate 20 can be set to operate and prohibit playing music that is not recognized by the digital content management system. In other cases, there may be certain owner or manual override provisions that allow the playing of music which is not recognized. In this way, unrecognized content can be prohibited or subject to authorized override. The digital content management system also provides effective accounting control and based thereon, provides reports for submission to the various copyright owners, label companies, software manufacturers, etc.

For the purpose of clarity and to better understand the operation of the system, the various components and functions have been separated. In implementing the system, these components may be combined. For example, the control gate may be part of the in-house system or integrated with the digital content management system or integrated with both of these functions. For example, the control gate could be a combination game/jukebox/input terminal available to customers. It could also be a modified jukebox having this terminal user file identification transfer/interaction capability.

There are also other arrangements for accessing audio/video files available for play in a public establishment and these arrangements can be used with the control gate function disclosed in the present application. Accessing authorized databases remotely located or onsite, provides a system that is less vulnerable to unauthorized play of material protected by copyright provisions while still satisfying or expanding the authorized play of material.

It is also possible to have the personal digital content devices include a separate function for interacting with public audio/video systems. These separate functions could be provided with the device or downloaded thereto. For example, known Music on Demand systems could be used with the present system to provide the appropriate authorization capability.

The digital content management system is authorized and tracks, and/or the play of the digital content. It is also possible for the control gate 20 to allow a user to communicate with an independent provider such as a Music on Demand provider. For example, a user can use the control gate 20 to access his account with the Music on Demand provider. This account can include a list of favourite music to simplify the selecting process for the user. The user can select the desired content and this content and/or identification information can be provided to the control gate. This content is preferably tracked as previously outlined by the digital content management system. It is also possible for authorization to be provided by the Music on Demand provider. For example, communication by the user using the control gate identifies this request as associated with use in a public establishment. The content could be streamed to the gate or transferred and temporarily stored, if authorized. Basically, the independent provider can be authorized from a copyright holder or group for authorizing this performance. Tracking can be provided by the control gate and/or the digital content management system regarding payments to the independent provider.

The present invention also includes the authorization of personal digital content devices for play of audio/video files on public audio/video systems by providing software to control this function.

The above system has been described primarily with respect to music and video content, however, it is also applicable to games and other forms of copyright material.

Although the digital content management system 40 can provide information feedback to the control gate 20 regarding the fee for playing of the copywritten material, this fee is preferably included in the cost per play charged by the control gate 20. With this arrangement, the digital content management system has authorized license provisions with the copyright owners or group providers.

The present invention and system provides an effective approach for the operator while allowing existing in-house audio and video systems to be used in a different manner and provide an additional income stream. Furthermore, it allows the operator to customize this in-house system for small group presentations. As can be appreciated, this could be suitable for business group lunches, etc.

As can be appreciated, the digital content management system will serve a large number of control gates at many commercial establishments.

There are many variations of this arrangement including the ability for the personal digital content devices merely to provide a list of the appropriate content to be played. IPod devices record the digital content in a manner easily used by the system. This list could have been derived from a pre-approved list available from the establishment or from the digital content system 40. For example, the material that is available for play could be provided on a website, etc., and the user could effectively pre-plan the particular material to be played.

The present system allows customers the capability of having their devices communicate with the audio/video system of a public establishment, in a convenient and effective manner. In a preferred embodiment, these devices provide identification tags that are used to identify the digital content to be played from an appropriate source, such as an authorized database of the audio/video system of the public establishment or a remote associated or independent database available to the audio/video system.

The above approach, where the personal digital content devices provide identification information of digital content to be played and the audio/video system matches the identification information with digital content authorized for play on a public system, is a preferred arrangement that reduces legal issues regarding transmission of files. The files of the personal devices, not normally authorized for public play, are not played on the audio/video system as only the identification information is used to determine the files and making the files available from an authorized source.

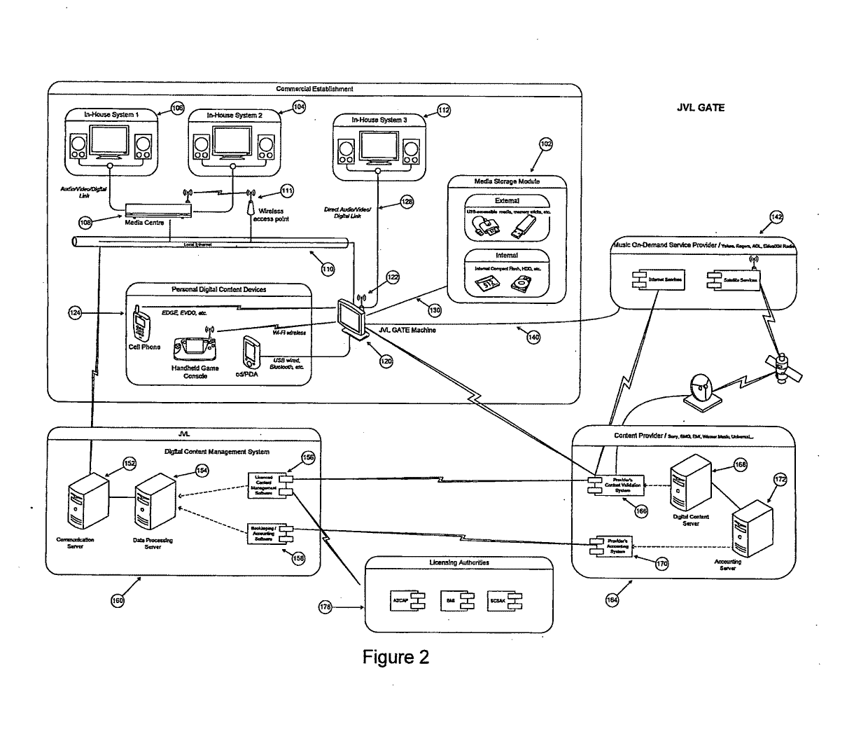

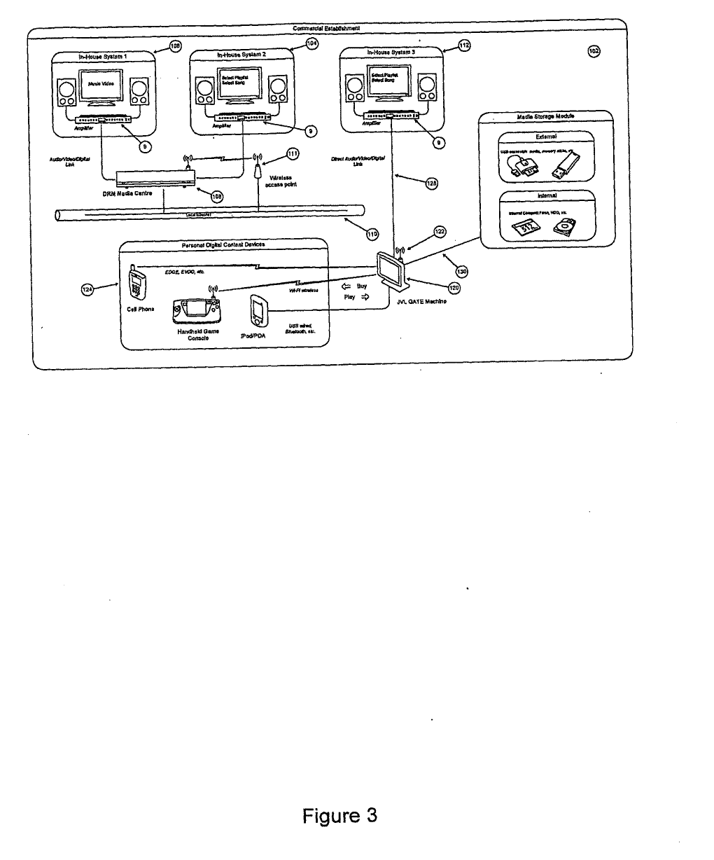

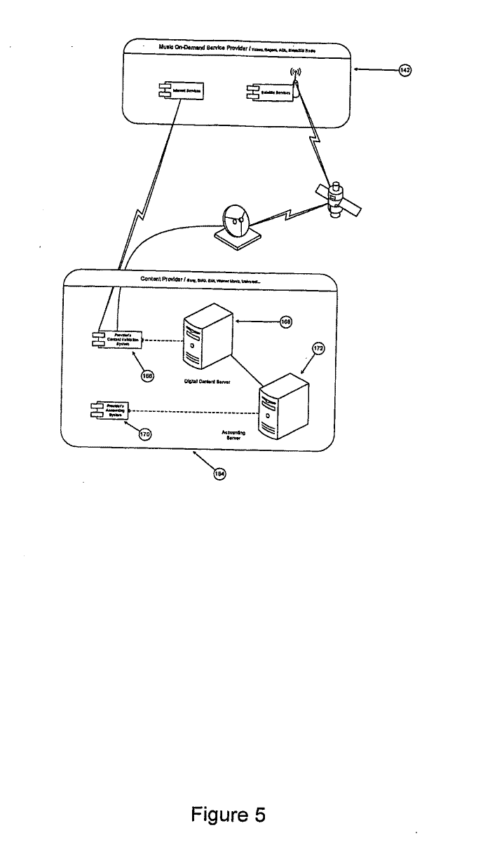

An alternate arrangement is shown in FIGS. 2 through 6. The networked entertainment performing system 100 shown in FIG. 2 is a networked system that is particularly suitable for commercial establishments such as restaurants and bars. A commercial establishment is generally shown as 102 and includes in-house audio/video systems 104 and 106 connected to the media center 108 which in turn is connected to a local area network such as a local ETHERNET connection to other computer devices within the commercial establishment. In-house system 112 is directly connected to the gate machine 120. This gate machine is physically connected to the local area network 110 and can also include a wireless communication function generally indicated as 122. Similarly, the local area network 110 includes its own wireless connection point indicated as 111. The gate machine 120 includes a physical or wireless connection to any of a number of personal digital content devices generally indicated as 124. For example, the gate machine 120 can communicate with cell phones, handheld game consoles, iPod or PDA type devices. These devices can be connected in a wireless manner or use a USB type connection.

Similarly, the gate machine 120 includes a connection 130 for communicating with known portable memory devices such as memory sticks, internal compact flash memory, portable hard disk devices or other suitable digital memory devices. In this way, the user can bring one of these devices to the commercial establishment and connect with the gate machine or one of the many gate machines provided in the commercial establishment for accessing and using the system in a specialized manner using digital content stored on these user devices.

The overall system includes Music on Demand Service Providers indicated as 142. It is now becoming more common for individual users to enter into a contract with a Music On Demand Provider indicated as 142 for the downloading and playing of music. This capability when used in association with the overall system allows a user to inform the gate machine 120 of a desire to play a particular song authorized by its Music On Demand Service Provider 142. As previously outlined, the gate machine could receive properly authorized digital content from the provider 142. The digital content, can be transferred as streaming video or audio, and forwarded to the in-house system 112 for the performance thereof. In this way, the digital content is not maintained by the system but is merely performed by the system. The authorization for this can be associated with the digital content management system or the Music on Demand Provider. The user will preferably pay the gate machine.

Many different payment arrangements and arrangements for appropriate authorization are possible.

The networked entertainment performing system preferably differs from earlier systems in that the actual digital content is not stored and subsequently performed. The digital content is streamed in real time and played on the particular system. This arrangement for many applications significantly reduces the legal issues associated with the various different content providers.

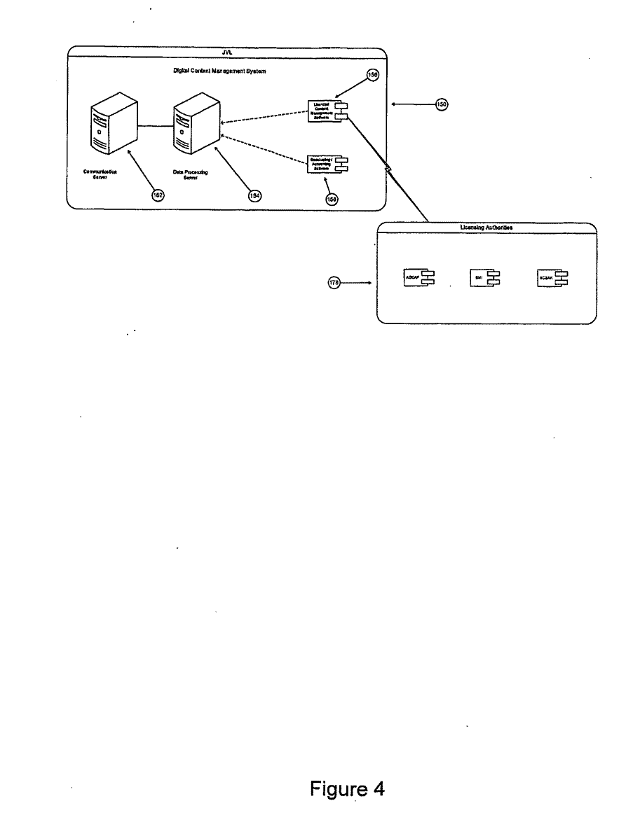

The remotely located digital content management system 150 as shown in FIGS. 2 and 4 includes a communication server 152 as well as a data processing server computer 154. Basically, the communication server 152 communicates with various control gates through the local area network 110, and preferably the INTERNET. The data processing server 154 can include license content management software for tracking of the various performing rights. Similarly, the data processing server 154 will include bookkeeping/accounting software for tracking of payments owed to the various providers. The Content Provider 164 communicates directly with the gate machine 120 and additionally communicates with the data processing server 154. The streamed audio/video signal is provided to the gate machine 120, and information with respect to the particular digital content is provided to the license content management software of the data processing server. Furthermore, the data processing server and the Content Provider 164 are also in communication between the particular accounting systems.

The content provider includes its own accounting system 170 and also includes a Content Validation System indicated as 166. The validation system is part of the Digital Content Server 168 and this is in communication with an Accounting Server shown as 172 and the Provider's Accounting Software indicated as 170. Basically, the Content Provider 164 provides the real time stream signal to the gate machine 120 and also provides a tracking arrangement recorded by the provider's Content Validation System 166, and the Licensed Content Management System 156 of the Data processing server 154. The Bookkeeping/Accounting Software of the Data processing server 154 is shown as 158.

The Content Provider 164 is shown with a number of particular parties such as MusicNET* Sony*, BMG*, EMI*, Warner Music*, and Universal*, for authorizing particular digital content. Other digital content may be authorized by the Licensing Authorities indicated as 178 which can include a number of different sources. Once again, the licensing authorities communicate with the License Content Management Software 156 of the of the Data processing server 154. Preferably, these systems provide the content or authorization for play. Trade-mark

Preferably, this particular system provides a networked arrangement for accommodating a host of sources for providing digital content to commercial establishments without the commercial establishment storing the content. The actual commercial establishment has equipment that typically receives the signal and reproduces or performs the particular work without the separate storing thereof. This significantly reduces the legal requirements in dealing with diverse content providers and their particular rights and control of content.

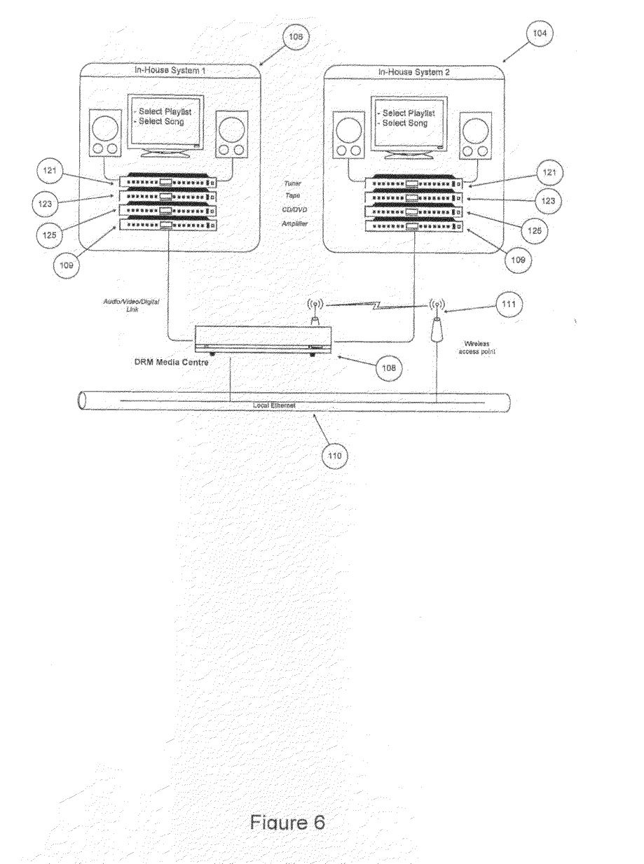

Additional details of the in-house systems 104 and 106 are shown in FIG. 6. The media center 108 cooperates with amplifiers 109 to be able to override other sources of digital content provided to the amplifiers. These other sources are conventional sources for in-house systems such as a tuner 121, a tape unit 123 and/or a CD/DVD device 125. The control gate 120 and the media center 108 allow automatic overriding of other signals.

Furthermore, a user may have his own work to be performed on the commercial system. This particular source is also accommodated by the system and the system can include particular checks to ensure that the work being performed is not subject to the rights of one of the other providers. With this system, it is in the interest of the actual commercial providers, such as the Music On Demand Provider 142, the Content Provider shown as 164, and the Licensing Authorities shown as 178, to provide the system at the commercial establishment, with information that allows identification and tracking of particular digital content. In this way, the system allows tracking of authorized users by their particular content provider. If during the performance of the work, the system recognizes the work as one requiring a different authorization, the performance may be terminated. As the system effectively charges the user a fee for the play of digital content, recognition of digital content provided by a user and incorrectly identified as not requiring further authorization, can be discouraged by forfeiture of payments already made.

Furthermore, the present system encourages the play of digital content properly authorized and tracked by the system and discourages unauthorized reproduction and performance.

With further advances in digital rights management, it will be possible to monitor, sample and/or provide summary information of digital content indicated as not requiring copyright compensation. Such information can be used to discourage unauthorized use by requiring further payments, forfeiture of existing payments and/or cancellation of privileges, if such content is recognized as requiring authorization.

The system can also be used to require material provided by a user to be subject to content review and approval prior to performance. This approval can include sampling tests or content control analyzed by the system or operator override for digital content indicated as not requiring authorization.

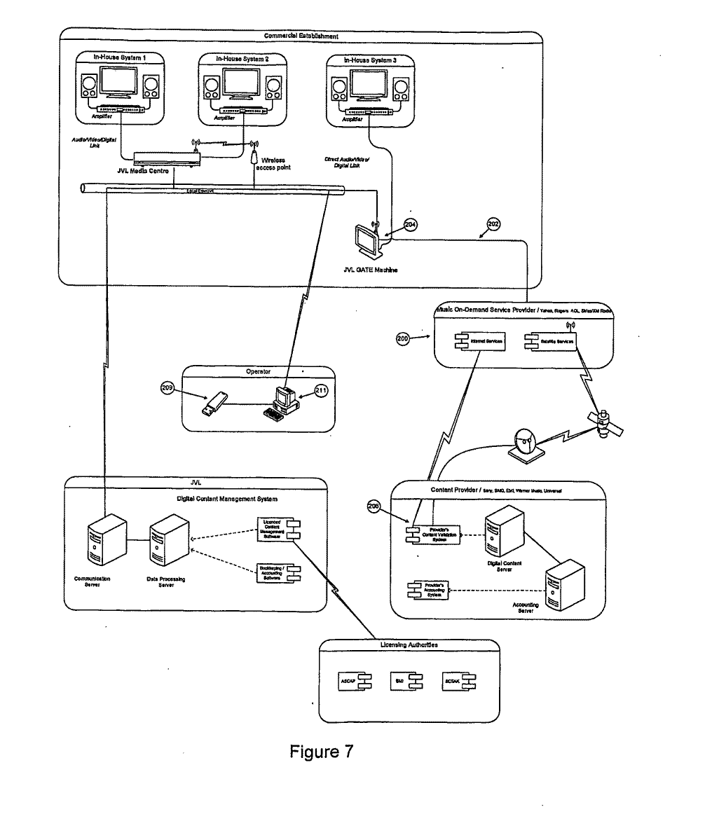

In FIG. 7, an alternate arrangement as shown that operates in a manner similar to the other embodiments. In this case, the Music On Demand Service Provider 200 includes link 202 to the gate machine 204. A user interacts with the gate machine 204 and selects different digital media content from the Music On Demand Service Provider 200. The provider 200 includes different connections with the content provider 206. The digital content is streamed to the gate machine 204 for play on any of the various in-house systems.

A further feature for providing digital content to the gate machine 204 or for use by the media center uses a portable memory device indicated as 209. The operator of the commercial establishment uses a different computer 211 to access the Content Provider 206. Digital content is downloaded to the portable memory device 209. The Operator then provides this digital content to the gate machine 204. This arrangement is useful where the real time streaming of digital content to the gate machine is not practical or reliable. Various safeguards can be provided, such as coding and/or time limited, or authorization requirement to protect unauthorized use of the digital content.

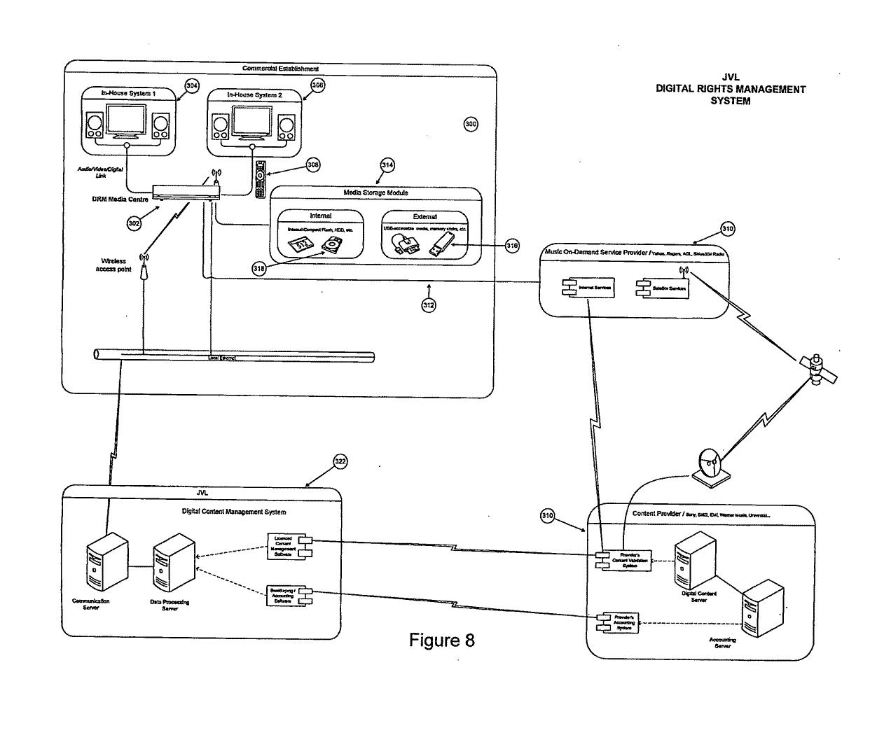

A further modification of the system is shown in FIG. 8. The system 300 for the public establishment includes the Digital Rights Management System 302 that allows effective communication with either of the in-house systems 304 or 306. A remote control device 308 allows the user to use the in-house systems, and in particular, the video screens thereof, as an effective input device. Basically, the remote control allows the user to access various menus and input the desired controls. With this arrangement, the Digital Rights Management Media Center 302 allows the in-house system to perform a number of the functions of the gate machine identified in the early systems.

The Music On Demand Service Provider 310 now includes a communication link 312 with the Digital Rights Management Media Center 302. The media center 302 also controls and is connected to the media storage module 314 that allows for recording of different digital content on different types of devices. For example, these could be user accessible media memory devices, generally indicated as 316, or internal memory devices such as compact flash hard drives etc. generally shown as 318. A user can request that the Music On Demand Service Provider 310 authorize the sale of a particular music selection or video selection and transfer to his portable memory device 316 or an internal of a particular device. With this option, a user is not only able to authorize the play of digital content, he is also able to purchase digital content and store the same on removable memory devices or internal memory devices. The particular costs and eventual accounting with the Music On Demand Service Provider and/or the content provider 320 is made through the Digital Content Management System identified as 322. The charge to the user is made by the control gate.

A further variation of this system is the possibility for the gate machine to cooperate with an operator controlled memory stick or other memory device. For example, the gate machine does not have good communication with the Digital Content Management System. It is possible for an operator to use a home computer or other system that does have good communication to download certain digital content or digital files to the portable memory device. These would be downloaded and would be specific for use in association with the Digital Rights Management System shown in the drawings.

The gate machine would then have access to this digital content for play on the system. It would track the use of the digital content and provide batch-type reporting to the Digital Content Management System and eventual communication to the content provider with the appropriate payments, etc. This digital content can be effectively managed by the content provider by providing necessary time limits where the digital content is accessible and/or particular codes necessary for further accessing of the files. Such passwords and other control parameters can be provided as the system contacts the Digital Contact Management System on a predetermined basis.

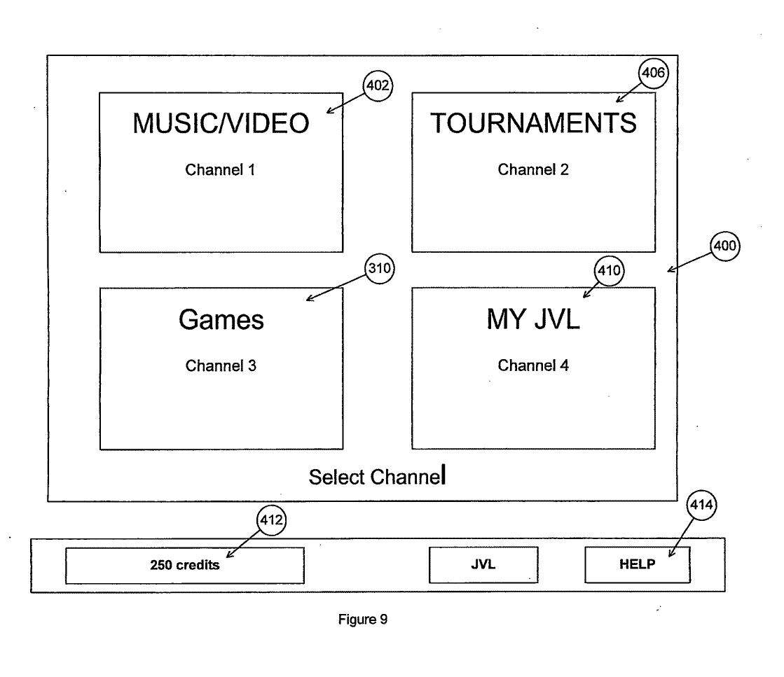

FIGS. 9 through 14 are a series of schematic screen shots presented to a user accessing the control gate or using the remote control of the system 300 shown in FIG. 8. Screen shot 400 includes four options, namely a music/video option 402, a tournament option 406, a game option 408, or a personalized option shown as 410. In addition, the screen shows the credits currently available to the user indicated as 412. A Help button is indicated as 414.

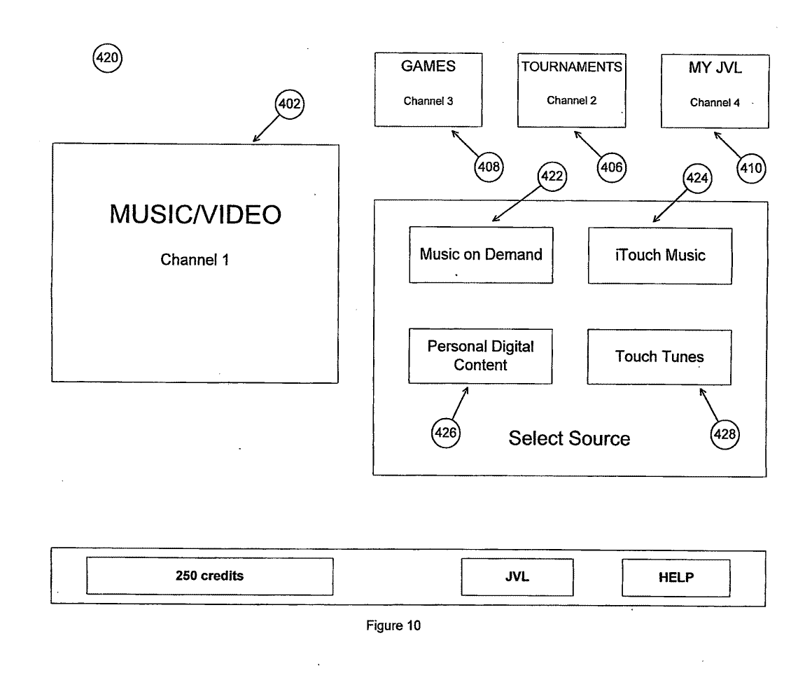

FIG. 10 is presented to the user when he has selected the music/video option indicated as 402. The screen shot 420 provides the user with the ability to go to the game option 408 or the game tournament option 406, or the personal option indicated as 410.

In FIG. 10, the user is now able to access music on demand indicated as 422, iTouch Music indicated as 424, personal digital content 426, or Touch Tunes indicated as 428. These are all particular sources of digital media content.

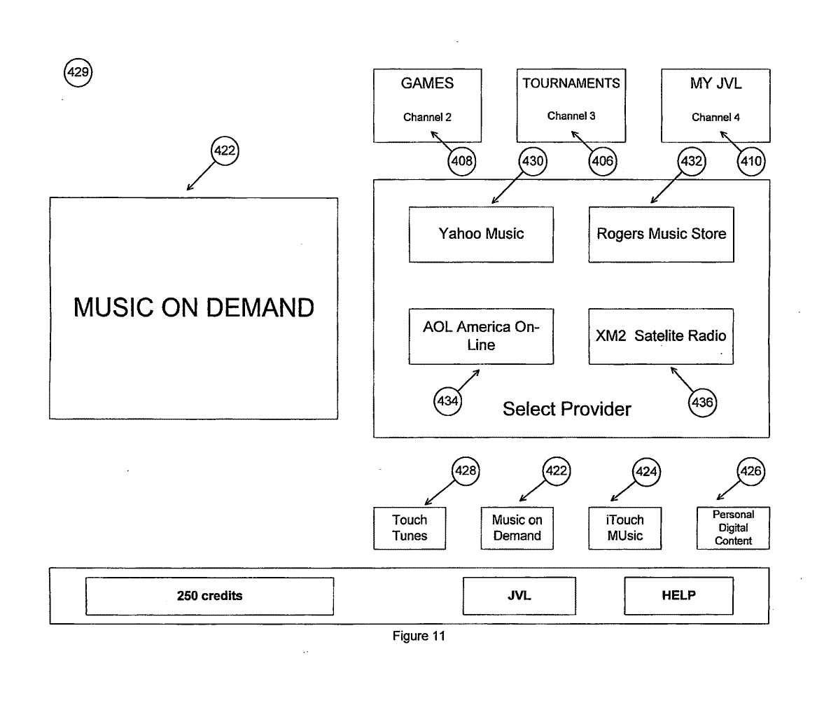

In FIG. 11, the user has activated the music on demand option 422 and is now presented with different sources of music on demand, such a Yahoo! Music 430, MusicNET, Rogers Music Store 432, AOL On-Line indicated as 434 or XM2 Satellite Radio indicated as 436. In this screen 429 of FIG. 11, the user can return to the options of FIG. 9 by actuating any of the options 406, 408 or 410, or can return to the screen of FIG. 10 by using the various controls provided as 422, 424, 426 and 428.

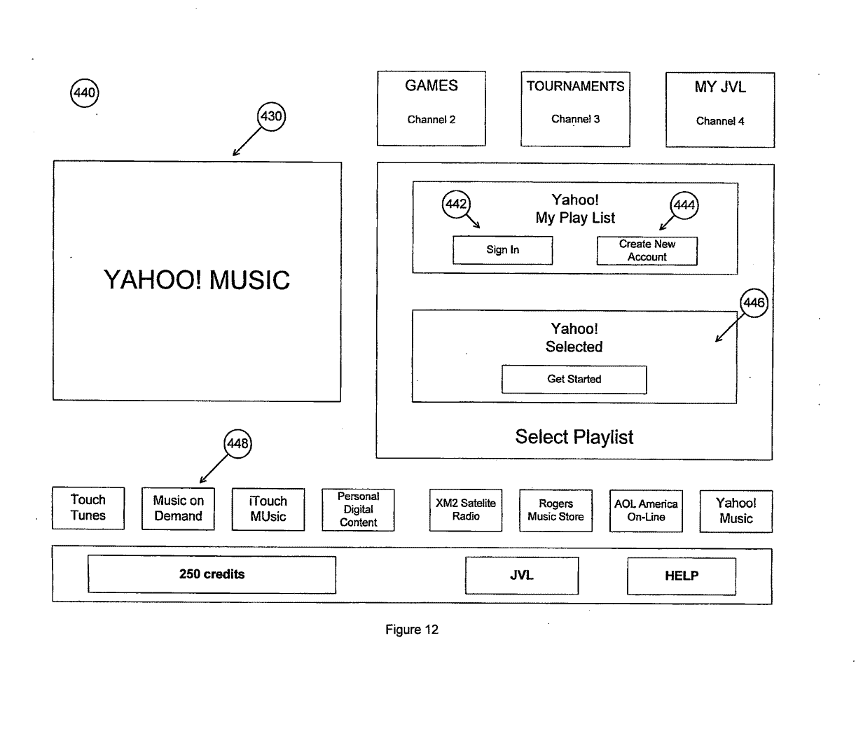

The screen shot 440 of FIG. 12 is presented when the user has selected Yahoo! Music 430. The user is presented with a sign in option 442 or create a new account option 444. This Sign In option allows the user access to his play list. Option 446 allows the user to access various listings within Yahoo! Earlier options presented to the user are also provided as generally indicated at 448.

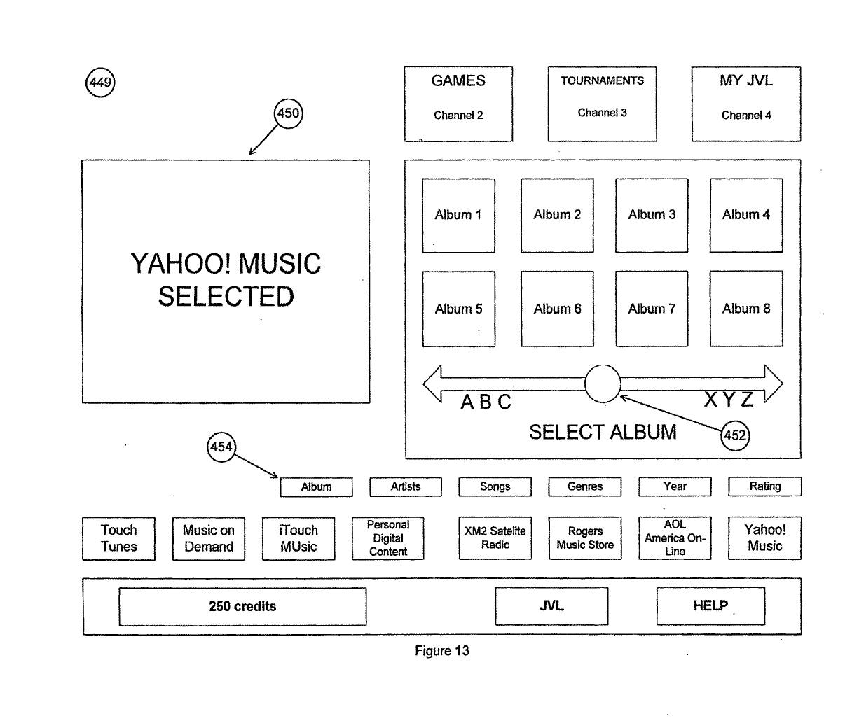

In FIG. 13, the user has selected Yahoo! Music Selected indicated as 450. This is presented in the screen shot indicated as 449. Various albums can be selected or different albums can be selected by using the slide bar control indicated as 452.

A series of control selections are also provided generally at 454 to allow a user to proceed to a desired album more quickly.

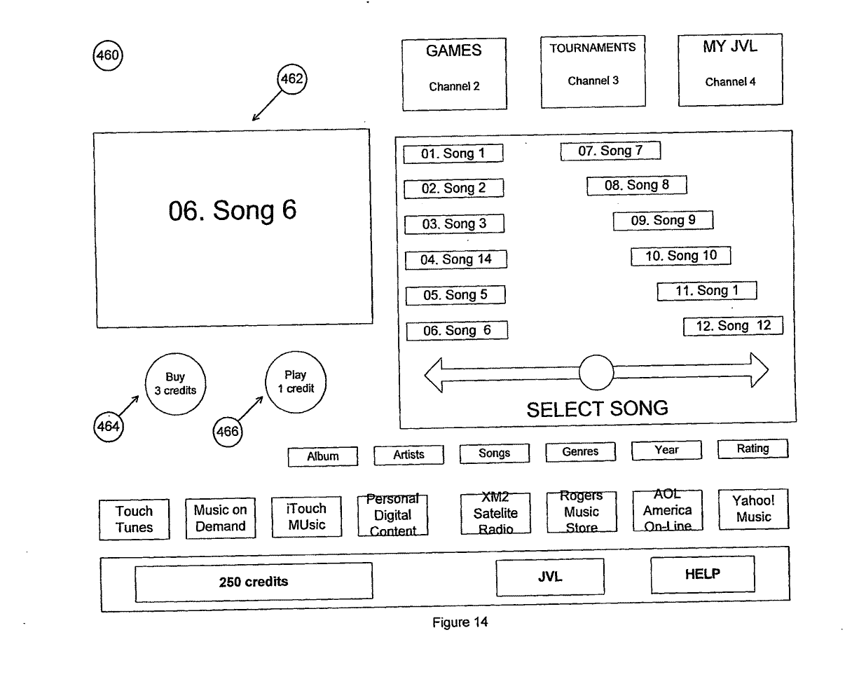

In the screen shot 460 of FIG. 14, the user has selected song 6 indicated as 462. The user is presented different options, namely the “buy” option 464 or the “play” option 466. If the “buy” option 464 is selected, the user would provide a device having appropriate memory storage to the control gate and connected to the same. He could also provide a portable memory device, such as a memory stick. For the “play” option 466, the charge is lower and this digital content can be provided to the control gate or the media center.

It is preferable that the various menus provided to the user allow the user to return to higher levels quickly. For example, the user can merely select the tournament option from the screen shot of 460 to return to these particular selections and options available to him. This allows a fast interaction with the control gate for inputting the necessary information.

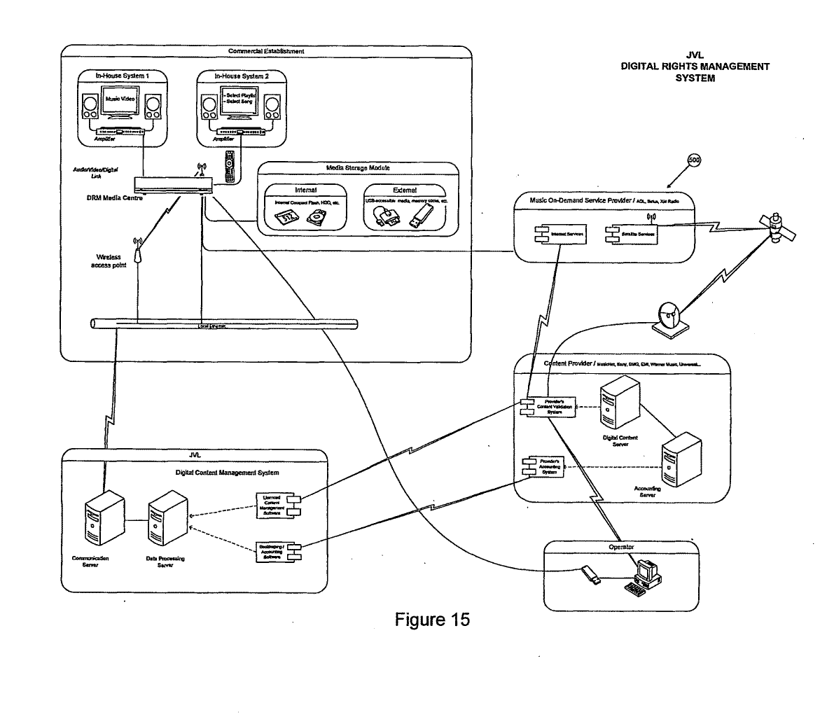

FIG. 15 shows an alternate system including use of portable memory devices for use with the media center for receiving digital content.

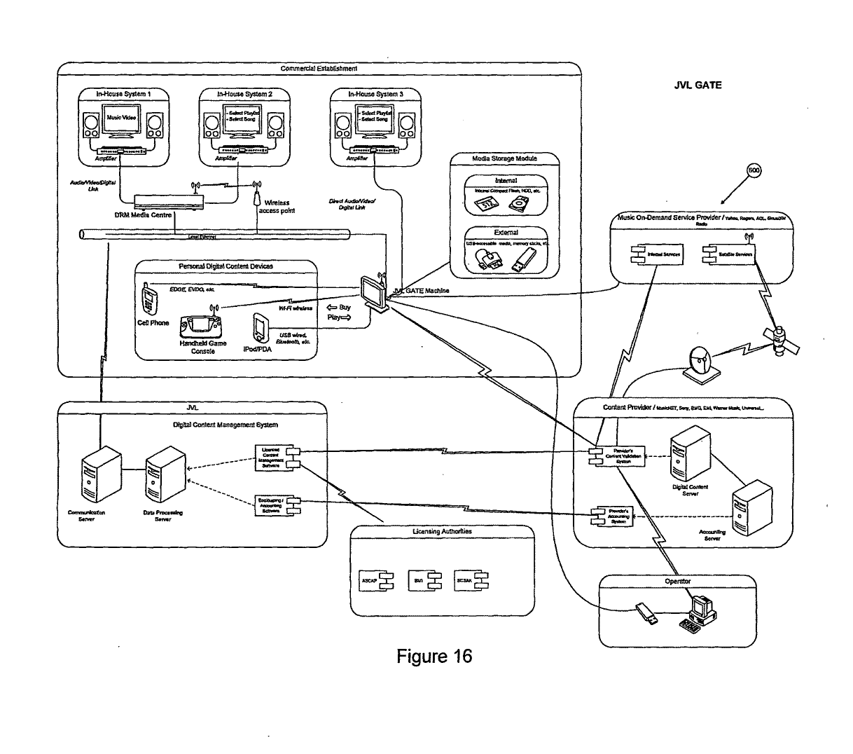

FIG. 16 shows a further alternate system 600.

Although various preferred embodiments of the present invention have been described herein in detail, it will be appreciated by those skilled in the art, that variations may be made thereto without departing from the spirit of the invention or the scope of the appended claims.

1. An automated authorization system for play of digital content in a public establishment comprising:
a user input system for identifying digital content requiring authorization for play to a site computer arrangement;
said site computer arrangement communicating with a central computer database and providing thereto the identified digital content;
said central computer database having at least identification information of a host of digital content where prearranged authorization for play has been obtained;
said central computer database providing authorization to said site computer arrangement for play of said identified digital content if said identified digital content is present in said database;
said central computer database tracking the authorized digital content to allow settlement with respect to the prearranged authorization; and
said site computer upon receipt of said authorization allowing the play of said identified digital content on a digital content play system.

2. An automated authorization system as claimed in claim 1 wherein said site computer receives said digital content as streaming digital content and provides said streaming digital content to said digital content play system.

3. An automated authorization system as claimed in claim 1 wherein said central computer database provides to said site computer digital content based on said identified digital content.

4. An automated authorization system as claimed in claim 1 wherein said site computer database receives said digital content from a source other than said central computer database, and said central computer database tracks digital content provided to said site computer from said other source for settlement.

5. An automated authorization system as claimed in claim 1 including as part of said site computer a user payment system and a fee is charged the user by said site computer for the play of said digital content.

6. An automated authorization system as claimed in claim 1 including a series of sources that provide digital content to said site computer.

7. An automated authorization system for use in a public establishment comprising:
a central computer database and a series of site computer arrangements in communication therewith;
each site computer arrangement including a user input system for identifying digital content requiring authorization for play;
said central computer database having a database of identified digital content for play by any of said site computer arrangements where prearranged authorization for play of said digital content has been obtained;
each site computer upon a user identifying digital content for play communicating a request with said central computer database to receive authorization;
said central computer comparing any requests to identified digital content in said database and providing authorization for digital content that is present in said database;
said site computer upon receipt of said authorization obtaining said digital content as streaming digital content and allowing play thereof on a digital content play system of a public establishment;
said central computer database tracking the authorized digital content for settlement associated with said prearranged authorization.

8. A media control system for the play of media files in a public establishment comprising a digital content review arrangement adapted to communicate with a control gate that forwards to said digital content review arrangement media files or summary information of said media files sufficient to identify, the media files with known media files contained in a database of said digital content review arrangement;
said control gate including an input for communicating with personal portable digital content devices and receive therefrom requested media files to be played on an media play system of said public establishment;
said control gate forwarding said requested media files or said summary information received from said personal portable digital content devices to said digital content review arrangement for identification;
said control gate provides to said media play system any of said requested media files or authorization with respect to the requested media file that have been identified by said digital content review arrangement; and
wherein said digital content review arrangement tracks the play of identified media files on said media play system.

9. A media control system as claimed in claim 8 wherein said control gate includes a payment arrangement for playing of identified media files on said media play system.

10. A media control system as claimed in claim 9 wherein said control gate includes a touch screen for user input and software providing input screens to effect the connection of a personal portable digital content device and transfer of media files for possible play on said media play system.

11. A media control system as claimed in claim 8 wherein said digital content review arrangement includes an accounting function and said database of media files includes royalty payment information, said accounting function tracking media file play information and royalty information to allow payments and reports to a licensing group or groups.

12. A media control system as claimed in claim 8 wherein said control gate is part of a video game terminal including a payment receiving capability.

13. A media control system as claimed in claim 12 wherein said personal portable digital content devices includes hand held game consoles.

14. A media control system as claimed in claim 12 wherein said personal portable digital content devices include cell phones, iPod type devices, MP3 players and memory devices.

15. A media control system as claimed in claim 8 wherein said digital content review arrangement includes a communication server and a data processing server.

16. A media control system as claimed in claim 15 including a local network connection of said control gate with said digital content review arrangement.

17. A media control system as claimed in claim 16 including a series of control gates with each control gate in communication with said digital content review arrangement and a series of media play systems controlled by said control gates.

18. A media control system as claimed in claim 17 wherein said control gates are part of a separate media play system that plays predetermined media files not provided by a user.

19. A media control system for a public establishment comprising art input arrangement for receiving at least media file identification information of files to be played on a media file play system of the public establishment from a customers' personal digital devices having said media file identification information;
a computing arrangement for receiving said at least media file identification information and accessing a database of known media files and using said at least media file identification information to locate the particular media file; and playing said particular media file on said media file play system.

20. A media control system as claimed in claim 19 including a payment arrangement associated with play of said media files and wherein said personal digital devices include cell phones, iPod type devices, MP3 play memory devices, and handheld game consoles.

21. (canceled)
